(19) United States
(12) Patent Application Publication
(10) Pub. No.: US 2026/0205317 A1
(43) Pub. Date: Jul. 16, 2026

(54) UTILIZING VIRTUAL DATA NETWORK NAMES TO DYNAMICALLY CHARGE UE FEATURE USAGE

(71) Applicant: T-MOBILE INNOVATIONS LLC, Overland Park, KS (US)

(72) Inventors: Murugappan PALANIAPPAN, Issaquah, WA (US); Deepthi JONNALA, Issaquah, WA (US); Thomas Keith TERWILLIGER, JR., Martinsburg, WV (US)

(21) Appl. No.: 19/020,317

(22) Filed: Jan. 14, 2025

(51) Int. Cl. H04L 12/14; H04L 41/0894; H04L 47/28; H04L 67/306; H04W 4/24

(52) U.S. Cl. CPC H04L 12/1407; H04L 41/0894; H04L 47/286; H04L 67/306; H04W 4/24

(57) ABSTRACT

Systems and methods are contemplated herein for generating and utilizing virtual DNNs within a network. The method may include receiving, at a session network function (NF), from a user equipment (UE), a UE-configured data network name (DNN). The method may include determining, based on a charging characteristic associated with the UE, to assign a virtual DNN to at least some network communications associated with an active session of the UE. The method may include communicating the virtual DNN to a policy NF and receiving a plurality of policies associated with the virtual DNN. The method may include communicating the plurality of policies to a charging NF.

### SUMMARY

The present disclosure is directed, in part to generating virtual data network names (DNNs) within a network to enable the online charging of premium features utilized by a user equipment (UE), substantially as shown and/or described in connection with at least one of the figures, and as set forth more completely in the claims.

UEs, particularly internet of things (IoT) devices, are often charged on a per-device basis, such as a recurring subscription monthly or an annually charge for each device. Other bases of charging may include usage-based charging, flat rate, custom pricing, and the like. However, existing UE charging approaches lack flexibility to charge particular features (e.g., premium features) in real-time (i.e., online charging) and other features (e.g., basic features) after usage has occurred (i.e., offline charging). The present disclosure is directed to systems and methods for generating and utilizing virtual data network names (DNNs) to enable feature-based online charging of premium features utilized by a UE. A data management function (DMF) may receive one or more charging characteristics associated with one or more premium features provisioned to the UE, such as hotspot. A session network function (NF) may determine whether the one or more charging characteristics trigger the assignment of a virtual DNN associated with the one or more premium features. The session NF may retrieve one or more policies associated with online charging of the premium feature the UE is attempting to utilize. The session NF may communicate the one or more policies to a charging NF, which may cause the online charging of the premium feature utilized by the UE. Each of online and offline usage of the UE’s utilization of various features may be metered, rated, and presented on an enterprise platform.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary call flow for generating and utilizing virtual DNNs within a network in which implementations of the present disclosure may be employed;

FIG. 4 illustrates a flow diagram of an exemplary method for generating virtual DNNs within a network in which implementations of the present disclosure may be employed;

FIG. 5 illustrates a flow diagram of an exemplary method for generating virtual DNNs within a network in which implementations of the present disclosure may be employed; and

FIG. 6 illustrates a flow diagram of an exemplary method for utilizing virtual DNNs within a network in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, users and entities (e.g., enterprises, governments, nonprofits) often employ user equipments (UEs), such as internet of things (IoT) devices (e.g., sensors, tracking devices), to monitor, remotely manage, automate, and/or communicate data across various systems. For example, a smart meter is a UE, as it communicates with a network to provide and update data such that an enterprise associated with the UE (e.g., a utility company) may view the data on an application. In another example, an enterprise may manage numerous UEs, such as cargo-tracking IoT devices on fleet vehicles, facility-sensing IoT devices within a production facility, IoT devices that monitor the performance of remote assets, employee-operated UEs (e.g., cell phones, activity trackers), and the like. Various features may be provisioned to a particular UE. For example, a UE may be configured to utilize hotspot features, quality on demand (QoD) features, VPN connections, quality of service (QoS) priority, and the like.

Conventionally, UEs managed by enterprises are often charged on a per-device basis, such as a recurring monthly subscription or an annual charge for each device. For example, an enterprise managing a fleet of vehicles equipped with tracking UEs may pay $100 a month for each UE positioned on each vehicle. Other bases of charging may include usage-based charging, flat rate, custom pricing, and the like. However, existing UE charging approaches lack flexibility to charge particular features (e.g., premium features) in real-time (i.e., online charging) and other features (e.g., basic features) after usage has occurred (i.e., offline charging). Thus, systems and methods enabling such flexible feature-based real-time charging of UEs are desirable.

In contrast to conventional solutions and to provide a flexible and robust approach to charging UEs, the present disclosure is directed to systems and methods for utilizing virtual data network names (DNNs) to enable feature-based online charging of UEs. A data management function (DMF), such as a unified data management (UDM) function, may be informed when one or more premium features are provisioned to the UE. The DMF may receive one or more charging characteristics associated with the one or more premium features provisioned to the UE. The DMF may store this information at a profile associated with the UE. When a session NF, such as a session management function (SMF), accesses the profile associated with the UE, the session NF may determine whether the one or more charging characteristics indicate the session NF should assign a virtual DNN associated with the one or more features. Any virtual DNN assigned by the session NF may reflect and/or indicate which premium feature the UE is attempting to utilize. The session NF may retrieve one or more policies associated with online charging the premium feature the UE is utilizing and/or attempting to utilize. The session NF may communicate the one or more policies to a charging NF, such as a charging function (CHF), which may implement the online charging of the premium feature utilized by the UE. Each of online and offline usage of the UE’s utilization of premium features may be metered, rated, and presented on an enterprise platform. This charging solution provides a more robust and flexible approach to charging UEs on a feature basis, such that the UE’s usage of a premium feature may be charged online while the UE’s usage of another feature (e.g., a basic feature) may be charged offline.

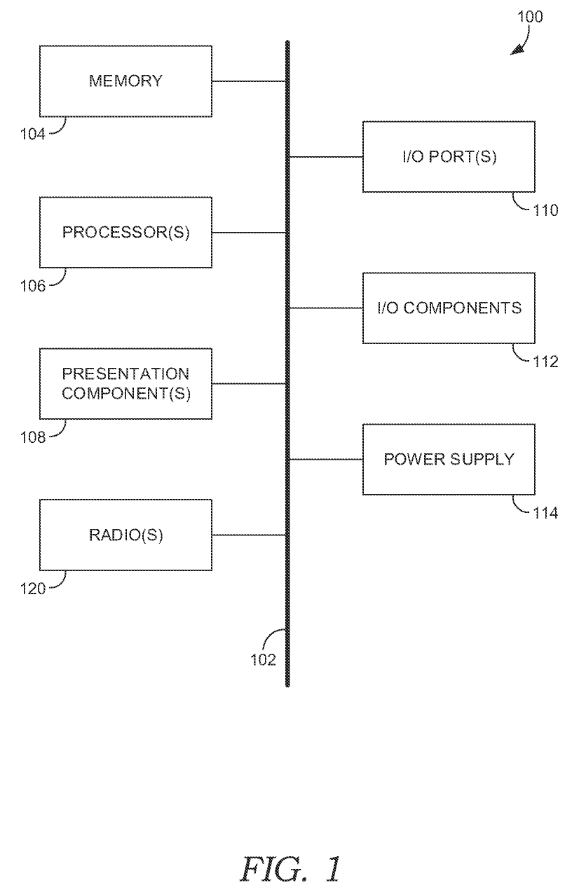

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of the one or more I/O components 112. Also, processors, such as the one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as the bus 102, the memory 104 or the one or more I/O components 112. The one or more presentation components 108 presents data indications to a person or other device. Exemplary one or more presentation components 108 include a display device, speaker, printing component, vibrating component, etc. The one or more I/O ports 110 allow computing device 100 to be logically coupled to other devices including the one or more I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, the radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

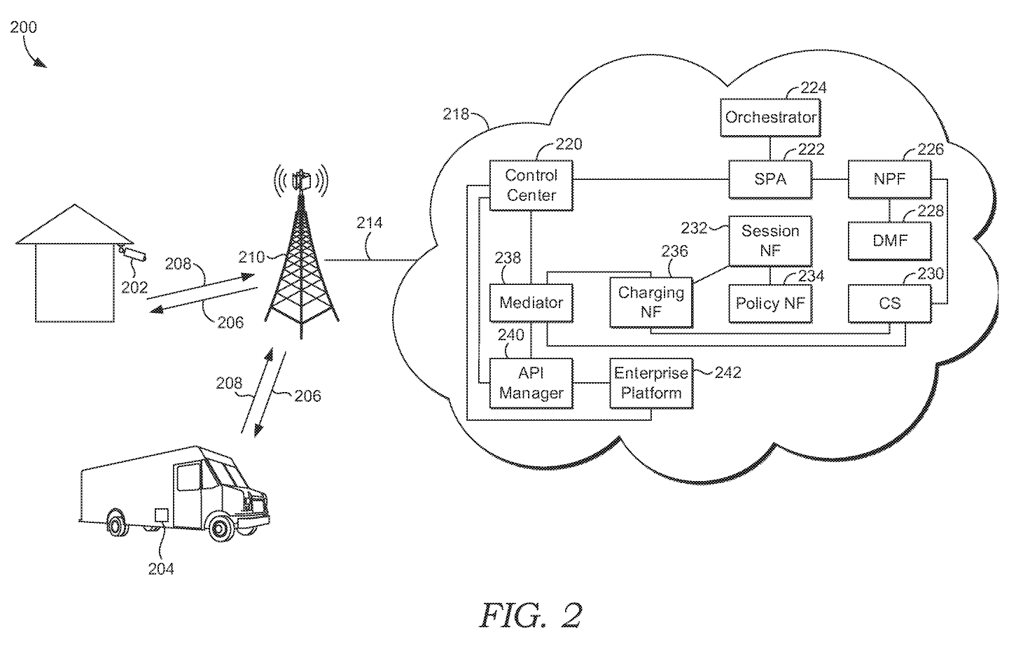

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment 200 be interpreted as having any dependency or requirement relating to any one or combination of components illustrated.

Network environment 200 represents a high level and simplified view of relevant portions of one or more modern wireless telecommunication networks. At a high level, the network environment 200 may generally be said to comprise one or more UEs, such as a first UE 202 and/or a second UE 204, one or more base stations, such as a base station 210, and a core network 218, though in some implementations, it may not be necessary for certain features to be present. Similarly, while each component is shown in the singular, it is expressly contemplated that there may be more than one of the components described. The network environment may include a number of routers, switches, and the like. The network environment 200 is generally configured for wirelessly connecting the first UE 202 and/or the second UE 204 to data or services that may be accessible on one or more application servers or other functions, nodes, or servers not pictured in FIG. 2 so as to not obscure the focus on the present disclosure.

The network environment 200 comprises the first UE 202 and/or the second UE 204. The first UE 202 is illustrated as a surveillance camera affixed to an exterior of a residential home, and the second UE 204 is illustrated as a carrier tracking sensor affixed to and/or within a commercial vehicle. While illustrated as specific IoT device examples, the first UE 202 and/or the second UE 204 and may take any number of forms, including any device discussed with respect to FIG. 1 and may have any one or more components or features of the computing device 100 of FIG. 1. The first UE 202 and/or the second UE 204 may take the form of smart meters (e.g., smart electricity meters, smart water meters), smart sensors (traffic sensors, air quality sensors, soil moisture sensors, temperature sensors), or other smart devices (e.g., fitness tracker, light fixtures, door locks, doorbells), for example. The first UE 202 and/or the second UE 204 may communicate with one or more networks to provide and/or update information, present live information, or a combination of these to one or more application servers. In aspects, the first UE 202 and/or the second UE 204 are IoT devices managed by an enterprise (e.g., fleet-tracking IoT devices, smart meters).

The network environment 200 comprises one or more base stations, such as the base station 210, to which the first UE 202 and/or the second UE 204 may potentially connect to (also referred to as ‘camping on,’ ‘attaching,’ in the industry). Though network environment 200 is illustrated with one base station 210, one skilled in the art will appreciate that more or fewer base stations may be present in any particular network environment. The base station 210 of the network environment 200 is configured to wirelessly communicate with various devices, such as the first UE 202 and/or the second UE 204. In aspects, the base station 210 may communicate with the first UE 202 and/or the second UE 204 using any wireless telecommunication protocol desired by a network operator, including but not limited to 2G, 3G, 4G, 5G, 6G, 802.11x, LoRa, LoRaWAN, and the like. The base station 210 may communicate signals to one or more UEs (e.g., the first UE 202 and/or the second UE 204) via a downlink 206 and receive signals from one or more UEs via uplink 208. In response to receiving certain requests from the first UE 202 and/or the second UE 204, for example, the base station 210 may communicate with the core network 218 via a backhaul 214. For example, in order for the first UE 202 and/or the second UE 204 to connect to a desired application server, the first UE 202 and/or the second UE 204 may communicate an attach request to the base station 210, which may, in response, communicate a registration request to the core network 218 via the backhaul 214.

The core network 218 may comprise one or more network functions (NFs). As used herein, the term “network function” is used to describe a computer processing module and/or one or more computer executable services being executed on one or more computing processing modules. NFs within the core network 218 are defined by their function, as the core network 218, in some aspects, may be a service-based architecture. The core network 218 may comprise NFs that include any one or more of a control center 220, a subscriber provisioning application (SPA) 222, an orchestrator 224, a network provisioning function (NPF) 226, a data management function (DMF) 228, a charging system (CS) 230, a session NF 232, a policy NF 234, a charging NF 236, a mediator 238, an application programming interface (API) manager 240, and an enterprise platform 242. Each of these NFs may communicate with each other, directly or indirectly, via interfaces existing between them. Each of the preceding NFs may take different forms, including consolidated or distributed forms that perform the same general operations. In other architectures or protocols, the NFs may be given other names, however, the NFs herein refer to functions, not specifically identified components.

Though the control center 220, the SPA 222, the orchestrator 224, the NPF 226, the DMF 228, the CS 230, the session NF 232, the policy NF 234, the charging NF 236, the mediator 238, the API manager 240, and the enterprise platform 242 are illustrated in the core network 218, the core network 218 may have more or fewer NFs than shown. For example, the core network 218 may include a serving gateway (SGW), a mobility NF (e.g., an access and mobility management function (AMF), a mobility management entity (MME)) and/or a non-IP data delivery (NIDD) server (e.g., such as to enable first UE 202 and/or the second UE 204 to connect to an NB-IoT network). Further, though the control center 220, the SPA 222, the orchestrator 224, the NPF 226, the DMF 228, the CS 230, the session NF 232, the policy NF 234, the charging NF 236, the mediator 238, the API manager 240, and the enterprise platform 242 are illustrated as disposed within the core network 218, it is expressly contemplated that the location in the network environment 200 is non-limiting. For example, the NFs described above may be disposed between the base station 210 and the core network 218 (i.e., the network edge) or may be isolated as stand-alone components, or a combination of these. While each of the NFs described above are illustrated in the singular, it is expressly contemplated that the network environment 200 may include one or more of each of the NFs described above.

The control center 220, for example, is generally responsible for connecting, provisioning, and/or deploying UEs. In aspects, the control center 220 may communicate with the SPA 222, such as to inform the SPA 222 that one or more UEs (e.g., a particular subscriber identity module (SIM) associated with the UE) are connected and/or deployed, one or more services are provisioned to the one or more UEs, and the like, such that the SPA 222 may communicate at least some of this information to downstream NFs. In some aspects, the control center 220 is not present in the network environment 200, and instead, its functions are performed by any one or more of the NFs described herein and/or an alternative UE onboarding manager NF. In aspects, the control center 220 may be responsible for charging, based on received call detail records (CDRs) from various NFs, UEs based on their utilization of network resources and submitting charges to one or more billing systems.

The SPA 222, for example, is generally responsible for facilitating the activation, deactivation, provisioning, and management of UEs and/or features available to UEs within a network. In aspects, the SPA 222 maintains a database of various features associated with a particular SIM associated with a UE, such as the first UE 202 and/or the second UE 204. In some aspects, at least a portion of this information may originate from the control center 220. In aspects, the SPA 222 maintains a database of eligible features associated with a particular SIM. In aspects, at least some of the information stored in the database of the SPA 222 is communicated to and/or accessed by the NPF 226. In aspects, the SPA 222 is a subscriber provisioning and query application (SPQA).

The orchestrator 224, for example, is generally responsible for receiving service order requests, such as from UEs and/or from enterprises managing UEs (e.g., from an enterprise management platform). In aspects, the orchestrator 224 communicates with the SPA 222 to determine whether a SIM requesting a particular network feature is onboarded, what features are provisioned to the SIM, and/or whether the UE is eligible to receive the feature. For example, the orchestrator 224 may receive a request to provision hotspot to a particular UE, such as the first UE 202 and/or the second UE 204. In this example, the orchestrator 224 may communicate with and/or access data from the SPA 222 to determine whether the UE is eligible for hotspot. In aspects, the orchestrator 224 may provision one or more particular features (e.g., hotspot) to the UE after determining the UE is eligible for such features. In aspects, the orchestrator 224 may inform the SPA 222 that such features have been provisioned to the SIM associated with the UE. In aspects, the orchestrator 224 is an order orchestrator or other NF configured to process and provision particular features to UEs.

The NPF 226, for example, is generally responsible for provisioning features to one or more UEs (e.g., to the SIMs associated with the one or more UEs), such as the first UE 202 and/or the second UE 204. The NPF 226 may receive information from the SPA 222, such as an indication that a SIM associated with a UE is activated and/or whether one or more features are provisioned to the SIM. In some aspects, the NPF 226 receives an indication from the SPA 222 that one or more premium features are provisioned to the UE (e.g., after the orchestrator 224 provisions such features to the UE). The NPF 226 may query its own database to determine which information received from the SPA 222 should be communicated to the DMF 228. In aspects, the NPF 226 may communicate the one or more premium features to the CS 230. In some aspects, the NPF 226 may generate and/or provision one or more charging characteristics associated with the one or more features provisioned to the UE. In aspects, the NPF 226 may communicate and/or store the one or more charging characteristics associated with the one or more features at the DMF 228, the CS 230, and/or one or more NFs not pictured in the network environment 200. In aspects, the NPF 226 is a network provisioning engine (NPE).

The DMF 228, for example, is generally responsible for hosting and storing device, user, subscription, and/or network data, and may be configured to provide various information to NFs. The DMF 228 may store various profiles, such as one or more profiles associated with a UE (e.g., user, subscriber, and/or device profiles), which may be modified to include the one or more charging characteristics generated by the NPF 226. In aspects, the DMF 228 may communicate with one or more NFs, such as the session NF 232, to provide information associated with the UE, such as the first UE 202 and/or the second UE 204. For example, the DMF 228 may provide the one or more charging characteristics to the session NF 232. In aspects, the DMF 228 is a unified data management function (UDM) or a home subscriber server (HSS).

The CS 230, for example, is generally responsible for real-time metering of network features utilized by UEs, such that the CS 230 facilitates the online charging of network features. In aspects, the CS 230 may be informed by the NPF 226 that the one or more features have been provisioned to the UE, such as the first UE 202 and/or the second UE 204. The CS 230 may meter the utilization of particular features by UEs and generate call detail records (CDRs) reflecting such utilization. In aspects, the CS 230 may implement charging policies associated with the metering of particular features in real-time by communicating with the policy NF 234. In aspects, the CS 230 is an online charging system (OCS).

The session NF 232, for example, is generally responsible for managing data sessions of UEs, such as the first UE 202 and/or the second UE 204. In aspects, the session NF 232 may receive one or more requests caused by a UE’s request to attach to the network, such as from a mobility NF (e.g., access and mobility function (AMF), mobility management entity (MME)) and/or a user plane NF (e.g., a user plane function (UPF), a serving gateway (SGW)). The session NF 232 may determine to assign a virtual data network name (DNN) based on the charging characteristic provisioned by the NPF 226. The session NF 232 may make this determination using logic, which may implement any one or more rules and/or the one or more charging characteristics provisioned by the NPF 226. In aspects, the session NF 232 may communicate with the policy NF 234, such as to access and/or receive one or more policies associated with the virtual DNN. In aspects, the session NF 232 is a session management function (SMF) or an MME.

The policy NF 234, for example, is generally responsible for managing charging policies and providing such policies to downstream NFs to charge UEs, such as the first UE 202 and/or the second UE 204. In aspects, the policy NF 234 may receive a virtual DNN from the session NF 232. In some aspects, the policy NF 234 retrieves a charging rules base name (CRBN) comprising one or more policies that may specify charging parameters (e.g., whether the UE’s utilization of particular network features should be charged online or offline, service quality criteria, data limits). In aspects, the policy NF 234 may communicate the CRBN associated with the virtual DNN and/or one or more policies (e.g., associated with the CRBN) associated with the virtual DNN to the session NF 232. In aspects, the policy NF 234 is a policy control function (PCF) or a policy and charging rules function (PCRF).

The charging NF 236, for example, is generally responsible for managing and processing charging data associated with a UE’s utilization of network resources, such as the first UE 202 and/or the second UE 204. The charging NF 236 may manage and process such charging data by communicating with the session NF 232. In aspects, the charging NF 236 causes and implements charging of UEs by implementing the one or more policies relating to charging (e.g., received from the session NF 232). In aspects, the charging NF 236 may offline meter the UE’s utilization of particular network features (e.g., basic features). In aspects, the charging NF 236 may instruct other NFs, such as the CS 230, to online meter the UE’s utilization of other particular network features (e.g., premium features). For example, the charging NF 236 may instruct the CS 230 to meter premium features online (e.g., in real-time). In aspects, the charging NF 236 may generate and/or cause the generation of call detail records (CDRs), which reflect detailed information about the UE’s utilization of the network, such as session duration, feature utilization, time, location, and the like. In aspects, the charging NF 236 is a charging function (CHF).

The mediator 238, for example, is generally responsible for receiving CDRs from one or more NFs involved in charging, such as the CS 230 and/or the charging NF 236. In aspects, the mediator 238 receives online CDRs from the CS 230 and offline (e.g., raw) CDRs from the charging NF 236. In aspects, the mediator 238 is configured with logic to determine which is an online CDR and which is an offline CDR, such as based on the DNN (e.g., UE-configured, virtual) associated with the CDR. The mediator 238 may mediate the communication of CDRs to other NFs or network components, such as the API manager 240 and/or the control center 220.

The API manager 240, for example, is generally responsible for managing APIs developed within the network, such as quality on demand (QoD). In aspects, the API manager 240 receives one or more CDRs (e.g., online CDRs), such as from the mediator 238. In aspects, the API manager 240 acts as a single source from which UE utilization of particular features (e.g., premium features) may be disseminated to a variety of platforms, such as the enterprise platform 242. The enterprise platform 242, for example, is generally responsible for providing relevant information, such as UE network utilization, to enterprises associated with the UE, such as the first UE 202 and/or the second UE 204. For example, an enterprise may wish to monitor each of its UEs, such as their utilization of particular network features (e.g., premium features), such as QoD or hotspot. In aspects, the enterprise platform 242 presents the UE’s utilization of the network to the enterprise associated with the UE.

Relevant to the present disclosure, various features may be provisioned to a particular UE, such as the first UE 202 and/or the second UE 204. A network operator may wish to charge different features in different ways. For example, the network operator may determine premium features, such as hotspot and QoD, should be charged online, in real-time, while more basic features, such as low-volume data transmission, should be charged offline, not in real-time.

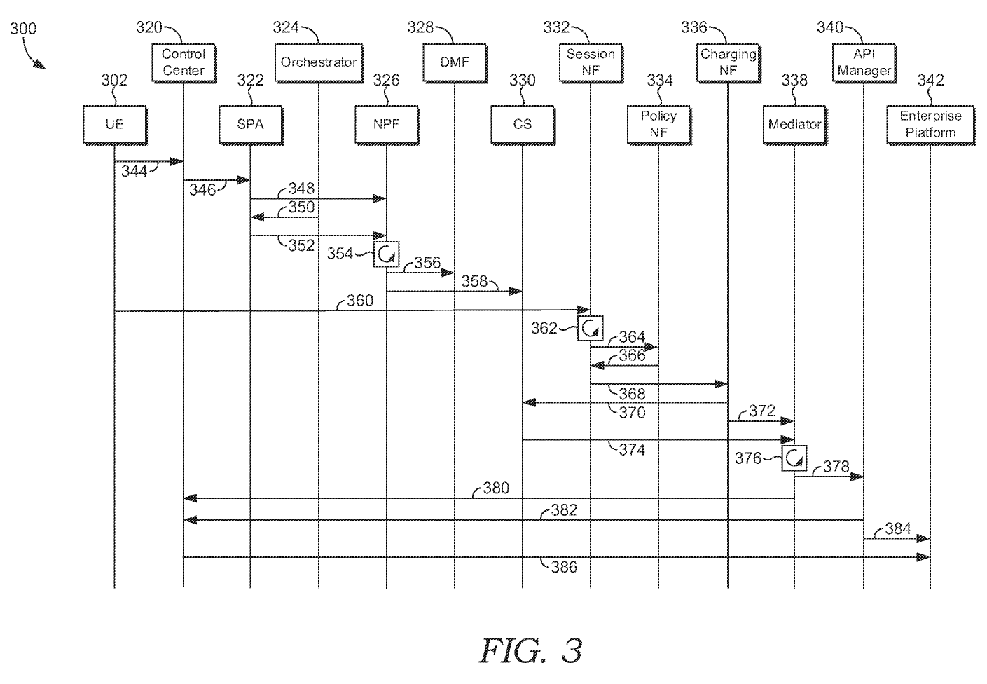

Turning now to FIG. 3, call flow diagram is illustrated in accordance with one or more aspects of the present disclosure and generally reflects systems and methods to generate and utilize virtual DNNs within a network. A call flow 300 may be performed by and/or facilitated by one or more NFs, one or more computer processing components, and/or a combination of these, as discussed in greater detail herein, and is not meant to exhaustively show every interaction that would be necessary to practice the invention, so as not to obscure the present disclosure. The call flow 300 may generally involve a UE 302 (e.g., the first UE 202 and/or the second UE 204 of FIG. 2), a control center 320 (e.g., the control center 220 of FIG. 2), a SPA 322 (e.g., the SPA 222 of FIG. 2), an orchestrator 324 (e.g., the orchestrator 224 of FIG. 2), an NPF 326 (e.g., the NPF 226 of FIG. 2), a DMF 328 (e.g., the DMF 228 of FIG. 2), a CS 330 (e.g., the CS 230 of FIG. 2), a session NF 332 (e.g., the session NF 232 of FIG. 2), a policy NF 334 (e.g., the policy NF 234), a charging NF 336 (e.g., the charging NF 236 of FIG. 2), a mediator 338 (e.g., the mediator 238 of FIG. 2), an API manager 340 (e.g., the API manager 240 of FIG. 2), and an enterprise platform 342 (e.g., the enterprise platform 242 of FIG. 2). The call flow 300 may include one or more aspects described with respect to FIG. 2. Each of the preceding NFs may take different forms, including consolidated or distributed forms that perform the same general operations. In other architectures or protocols, the NFs may be given other names, however, the NFs herein refer to functions, not specifically identified components.

At a first step 344, the UE 302 initiates communication with the network, such as an initial request to provision the UE 302 within the network. At the first step 344, the control center 320 receives the communication from the UE 302 or a communication caused by the communication from the UE 302. In aspects, the communication includes relevant information necessary for network access and authentication, such as identification information associated with the UE (e.g., a subscriber identity module (SIM), integrated circuit card identifier (ICCID), international mobile subscriber identity (IMSI), mobile station international subscriber directory number (MSISDN)).

At a second step 346, the control center 320 communicates activation information to the SPA 322, and the SPA 322 receives the activation information. In aspects, the activation information includes the identification information and a determination that the UE 302 has been activated and/or provisioned within the network (e.g., the SIM is activated for use and/or provisioned within the network). In aspects, the SPA 322 stores the activation information at a database within the SPA 322. At a third step 348, the SPA 322 communicates at least some of the activation information to the NPF 326, which may be communicated to one or more downstream NFs such as to enable network-level configurations enabling the UE 302 to function with the network. While not shown in the call flow 300, the NPF 326 may communicate at least some of the activation information to one or more NFs, such as the DMF 328, which may store information in one or more databases within and/or accessible by the DMF 328 (e.g., a unified data repository (UDR)).

In some aspects, at a fourth step 350, the orchestrator 324, requests information from the SPA 322 and/or accesses information at the SPA 322 (e.g., from the one or more databases of the SPA 322). In aspects, the orchestrator 324 requests and/or accesses information from the SPA 322 based on a request from the UE 302 and/or an enterprise associated with the UE 302 to provision and/or utilize one or more premium features (e.g., QoD, hotspot). In aspects, the orchestrator 324 requests and/or accesses information from the SPA 322 to determine whether the SIM associated with the UE 302 is activated and/or determine whether the UE 302 is entitled to receive such premium features. In aspects, the SPA 322 may inform the orchestrator 324 that the SIM is activated and/or that the UE 302 is entitled to receive the one or more premium features. In aspects, the orchestrator 324 activates the one or more premium features and informs the SPA 322 that the one or more premium features are provisioned to the UE 302.

In aspects, during the course of any one billing cycle, the UE 302 seeks to utilize one or more features, and, in aspects, these features may be classified as premium features or basic features. In aspects, any feature designated as a premium feature may be charged differently from other features (e.g., other premium features, basic features). Any particular feature that may be utilized by a UE within the network may be classified as a premium feature based on the feature consuming more network resources (relative to basic features), the value of the service the feature provides (e.g., convenience of the feature is valuable), market dynamics, quality of service (QoS) requirements (e.g., the QoS to provide the feature is higher than providing a basic feature), customer segmentation, newly released features, and/or a combination of these. Any particular feature that may be utilized by a UE within the network may be classified as a basic feature based on the above considerations. For example, a feature that utilizes fewer network resources, provides relatively little value of service, requires low QoS to be provided, is a well-known feature, and/or a combination of these may determine whether a feature is a basic feature. In some aspects, enterprises may negotiate to effectively classify premium features as basic features (and vis versa), which may also impact this determination. In aspects, premium features include hotspot, quality on demand (QoD), network slicing, enhanced QoS, augmented reality or virtual reality services, priority access, and the like.

The call flow 300 contemplates and describes the charging of the UE’s 302 utilization of both premium features and basic features, however, it is expressly contemplated that steps of the call flow 300 may be performed such only steps relevant to charging basic features are performed during a given timeframe (e.g., the UE’s 302 session, the billing cycle of the UE 302), only steps relevant to charging premium features are performed during a given session and/or billing cycle, or a combination of these (e.g., the UE 302 utilizes both a basic feature and a premium feature during a given session).

In some aspects, at a fifth step 352, the SPA 322 communicates an indication that the one or more premium features are provisioned to the UE 302 to the NPF 326, and the NPF 326 receives the indication that the one or more premium features are provisioned to the UE 302. At a sixth step 354, the NPF 326 performs logic to determine that one or more charging characteristics associated with the one or more premium features should be provisioned to one or more profiles associated with the UE 302, such as a subscriber profile, a subscription profile, and the like. For example, the NPF 326 may be configured to initiate provisioning of the one or more charging characteristics based on the feature being provisioned and/or whether the feature is determined to be a premium feature that should be charged online, in real-time. In aspects, the one or more charging characteristics may be accessed by downstream NFs and may enable unique charging configurations relating to the one or more premium features.

In some aspects, at a seventh step 356, the NPF 326 communicates the one or more charging characteristics associated with the one or more premium features to the DMF 328, and the DMF 328 receives the one or more charging characteristics. In aspects, the NPF 326 and/or the DMF 328 may store the one or more charging characteristics associated with the one or more premium features at one or more profiles associated with the UE 302 such that downstream NFs may access the one or more charging characteristics from the one or more profiles associated with the UE 302. At an eighth step 358, the NPF 326 communicates the one or more charging characteristics to the CS 330, and the CS 330 receives the one or more charging characteristics associated with the one or more premium features. The CS 330 may utilize the one or more charging characteristics to modulate downstream, real-time online charging of the one or more premium features. For example, the UE 302 may only have authorization to utilize a particular volume of data via hotspot, and the one or more charging characteristics may reflect this limit.

At a ninth step 360, the UE 302 communicates an attach request to the network, which is received by the session NF 332. A duration of time may occur between the eighth step 358 and the ninth step 360. For example, an enterprise associated with the UE 302 may onboard the UE but not utilize the UE 302 until it is installed and/or provided to an employee of the enterprise. In aspects, the attach request may be communicated to one or more intermediate NFs, such as the DMF 328 (e.g., an HSS, a UDM) and/or a user plane node (e.g., a user plane function (UPF), a serving gateway (SGW)) prior to reaching the session NF 332. In aspects, the session NF 332 may receive a UE-configured data network name (DNN) (which may also be an access point name (APN)), which the network may utilize to establish a session between the network and the UE 302. While not shown in the call flow 300 to not obscure the present disclosure, the session NF 332 may retrieve one or more charging characteristics associated with the UE 302 (e.g., the one or more charging characteristics associated with the one or more premium features), such as from the one or more profiles associated with the UE 302 at the DMF 327.

At a tenth step 362, the session NF 332 performs logic to determine whether a virtual DNN should be assigned to one or more network communications associated with the active session of the UE 302 (e.g., downstream communications between NFs relating to the UE 302 and/or its sessions with the network). In some aspects, the determination of whether to assign a virtual DNN may be determined based on the one or more charging characteristics associated with the UE 302 and/or based on one or more rules utilized by the session NF 332 to determine whether the UE 302 is utilizing a premium feature of the one or more premium features.

In aspects, the logic includes the session NF 332 comparing a charging characteristic with the UE-configured DNN received in the ninth step 360. In aspects, the one or more charging characteristics are mapped to one or more virtual DNNs and reflect the one or more premium features. For example, charging characteristic 1 may map to virtual DNN 1 and charging characteristic 2 may map to virtual DNN 2. In such aspects, the session NF 332 determines the UE-configured DNN does not correspond to the virtual DNN mapped to the charging characteristic of the one or more profiles associated with the UE 302 (e.g., the virtual DNN does not match the UE-configured DNN). In aspects, the session NF 332 may assign the virtual DNN mapped to the charging characteristic to one or more network communications associated with the active session of the UE 302 based on this determination. In other aspects, the session NF’s 332 determination of a mismatch between the virtual DNN mapped to the charging characteristic and the UE-configured DNN causes the session NF 332 to make one or more additional determinations using one or more rules.

In aspects, the logic includes the session NF 332 determining the UE 302 is utilizing the one or more premium features by utilizing one or more rules. In aspects, the session NF 332 may make one or more hotspot determinations. The session NF 332 may retrieve and/or access one or more parameters associated with the UE 302 that indicate the UE 302 is utilizing hotspot (e.g., time to live (TTL)). In aspects, the hotspot determination includes the session NF 332 determining whether the TTL associated with one or more data packets originating from the UE 302 in the active session matches or is within a threshold of a default TTL associated with the UE 302 (e.g., the TTL when the UE 302 is not utilizing hotspot features). In such aspects, where the TTL of the active session with the UE 302 does not match or surpasses the threshold of the default TTL, the session NF 332 determines to assign a virtual DNN. In such aspects, where the TTL of the active session with the UE 302 does match or is within the threshold of the default TTL, the session NF 332 may determine to employ additional rules (e.g., determine whether the UE 302 is utilizing other premium features) and/or utilize the UE-configured DNN for the one or more network communications associated with the active session of the UE 302.

In aspects, the session NF 332 makes one or more QoD determinations. In aspects, the QoD determination includes the session NF 332 determining what network slice is utilized by the UE 302 by accessing and/or retrieving one or more network slice identifiers (e.g., network slice selection assistance information (NSSAI)). In aspects, the QoD determination may include the session NF 332 determining whether the network slice utilized by the UE 302 in the active session matches a default network slice associated with the UE 302 (e.g., the network slice the UE 302 utilizes when not accessing QoD features). In such aspects, where the session NF 332 determines the network slice of the active session of the UE 302 does not match the default network slice, the session NF 332 determines to assign a virtual DNN. In such aspects, where the network slice of the active session of the UE 302 matches the default network slice, the session NF 332 may determine to employ additional rules (e.g., determine whether the UE 302 is utilizing other premium features) and/or utilize the UE-configured DNN for the one or more network communications associated with the active session of the UE 302.

In a first aspect of the tenth step 362, the session NF 332 may determine to assign a virtual DNN to one or more network communications associated with active session of the UE 302. The virtual DNN may include and/or reflect the premium feature the virtual DNN is mapped to. For example, the virtual DNN may reflect the particular network slice the UE 302 is utilizing, reflecting the UE’s 302 utilization of the premium QoD feature. In another example, the virtual DNN may reflect the TTL associated with one or more data packets originating from the UE 302 in the active session. In aspects, the virtual DNN may be communicated from the session NF 332 to downstream communications in the call flow 300. In a second aspect of the tenth step 362, the session NF 332 may determine not to assign a virtual DNN to the one or more network communications associated with the active session of the UE 302, and instead, continues the session using the UE-configured DNN, as described in more detail below.

At an eleventh step 364, based on the determination at the tenth step 362, the session NF 332 communicates the virtual DNN or the UE-configured DNN to the policy NF 334, and the policy NF 334 receives the virtual DNN or the UE-configured DNN from the session NF 332. In aspects, such as where the virtual DNN is assigned, the policy NF 334 retrieves one or more policies associated with the virtual DNN and/or the premium feature. In aspects, the one or more polices may be a group of policies of a charging rule base name (CRBN) associated with the virtual DNN and/or the premium feature. The one or more policies may control various charging configurations associated with the premium feature. For example, the UE 302 may be entitled to a particular volume of data via hotspot, and the one or more policies may define how this volume is metered, what kind of throttles to employ once the volume is reached, and/or the billing rate for the feature. In another example, the UE 302 may be entitled to particular data speeds once the UE 302 initiates QoD. The one or more policies may control these particularities associated with the premium feature utilized by the UE 302 in the active session, such as how to meter and bill the UE’s 302 utilization of the premium feature.

At a twelfth step 366, the policy NF 334 communicates the one or more policies associated with the virtual DNN and/or the premium feature to the session NF 332, and the session NF 332 receives the one or more policies associated with the virtual DNN and/or the premium feature. In aspects, the policy NF 334 communicates a CRBN associated with the virtual DNN and/or the premium feature. The CRBN may include the one or more policies associated with the virtual DNN and/or the premium feature or the session NF 332 accesses the one or more policies using the CRBN. In some aspects, the policy NF 334 communicates the one or more policies associated with the virtual DNN and/or the premium feature without communicating a CRBN. At a thirteenth step 368, the session NF 332 communicates the one or more policies associated with the virtual DNN and/or the premium feature to the charging NF 336, and the charging NF 336 receives the one or more policies associated with the virtual DNN and/or the premium feature (e.g., a CRBN associated with the virtual DNN and/or the premium feature).

In some aspects (e.g., where the feature to be metered is a premium feature), at the thirteenth step 368, the session NF 332 may communicate one or more flags, which are associated with the charging of the virtual DNN and/or the premium feature. In aspects, the one or more flags may indicate to the charging NF 336 that one or more features should be charged online (e.g., at the CS 330) or should be charged offline (e.g., at the charging NF 336). In aspects, the one or more flags may state and/or indicate the virtual DNN and/or the premium feature. In aspects, the one or more flags state and/or indicate the UE 302 is utilizing a premium feature in the active session. In aspects, the one or more flags may include a network slice identifier that corresponds to a network slice different from the default network slice, indicating the UE 302 is utilizing QoD during the active session. In aspects, the flag states and/or indicates the UE 302 is utilizing hotspot during the active session (e.g., TTL of UE 302 during the active session). In other aspects (e.g., where the feature to be metered is a basic feature), at the thirteenth step 368, the session NF 332 does not communicate the one or more flags or configures the one or more flags to indicate the basic feature should be charged offline.

In a first aspect of a fourteenth step 370, where the feature to be metered is a premium feature (e.g., hotspot, QoD), the charging NF 336 communicates a request to the CS 330 requesting the CS 330 to meter the UE’s 302 utilization of the premium feature online, based on the one or more flags received from the session NF 332, and the CS 330 receives a request to meter the UE’s 302 utilization of the premium feature. In response, the CS 330 may meter all utilization associated with the virtual DNN and/or the premium feature online, in real-time. In aspects, the request to the CS 330 may instruct the CS 330 to generate an online call detail record (CDR) and monitor, track, and record, in real-time (e.g., as the UE 302 utilizes the premium feature), the UE’s 302 utilization of the premium feature. The charging NF 336 may include the one or more flags, the virtual DNN, and/or another indication of the premium feature the CS 330 must monitor, track and/or record.

In a second aspect of the fourteenth step 370, where the feature to be metered is a basic feature (e.g., low-volume data transmission), the charging NF 336 may not request the CS 330 to meter the UE’s 302 utilization of the basic feature. Instead, the charging NF 336 may itself generate an offline CDR and process the UE’s 302 utilization of basic features offline, not in real-time. Offline processing may include periodically collecting the UE’s 302 utilization of basic features after the basic features have been utilized by the UE 302.

At a fifteenth step 372, when a basic feature was metered, the charging NF 336 communicates the offline CDR to the mediator 338, and the mediator 338 receives the offline CDR. In aspects, the offline CDR including one or more metering parameters. The one or more metering parameters (e.g., of the offline CDR and/or of the online CDR) may include any one or more of a start time (e.g., when the UE 302 initially accessed the feature), UE 302 identifiers (e.g., a SIM associated with the UE 302), subscriber identifiers (e.g., IMSI, MSISDN), feature identifiers (e.g., an indication that the feature is a basic feature, the one or more flags of the fourteenth step 370). In aspects, the offline CDR includes the UE-configured DNN. At a sixteenth step 374, if a premium feature was metered, the CS 330 communicates the online CDR to the mediator 338, and the mediator 338 receives the online CDR. In aspects, the online CDR includes the one or more metering parameters described with respect to the offline CDR. In some aspects, the one or more metering parameters may include the virtual DNN associated with the premium feature.

In some aspects, at a seventeenth step 376, the mediator 338 performs logic. In aspects, the logic includes determining which NF within the network to communicate a received CDR (e.g., the offline CDR and the online CDR). In aspects, the mediator 338 may determine whether the received CDR is an online CDR or an offline CDR. In some aspects, the mediator 338 inspects the received CDR for a DNN, such as the virtual DNN and the UE-configured DNN. In aspects, the mediator 338 may detect the presence of the virtual DNN and determine the received CDR is an online CDR and/or determine to communicate the online CDR to the API manager 340. In aspects, the mediator 338 may detect the presence of the UE-configured DNN and determine the received CDR is an offline CDR and/or determine to communicate the offline CDR to the control center 320.

In aspects, where the mediator 338 determines the received CDR is an online CDR (e.g., detects the presence of the virtual DNN), at an eighteenth step 378, the mediator 338 communicates the online CDR to the API manager 340. In aspects, at the API manager 340, the data of the online CDR may be extracted and/or collected and may be communicated to one or more downstream NFs or platforms for presentation to one or more users and/or enterprises associated with the UE 302.

In aspects, where the mediator 338 determines the received CDR is an offline CDR (e.g., detects the presence of the UE-configured DNN), at a nineteenth step 380, the mediator 338 communicates the offline CDR to the control center 320, and the control center 320 receives the offline CDR. At the control center 320, the control center 320 includes rules and/or logic to rate the UE’s 302 utilization of features (e.g., basic, premium). For example, the control center 320 may have rate information (e.g., a price associated with a unit of utilization of a feature) for each feature, whether basic or premium. At the nineteenth step, the control center 320 rates the offline CDR. In aspects, after rating, the control center 320 may communicate the rated offline CDR to one or more billing systems that may generate a bill associated with the one or more users and/or enterprises.

At a twentieth step 382, the API manager 340 communicates the online CDR to the control center 320, and the control center 320 receives the online CDR. At the control center 320, the control center 320 rates the UE’s utilization of the premium feature using various rules and/or logic. In aspects, after rating, the control center 320 communicates the rated online CDR to one or more billing systems that may generate a bill associated with the one or more users and/or enterprises. Advantageously, by communicating the online CDR to the API manager 340 prior to the control center 320 (e.g., at the eighteenth step 378), the API manager 340 may separately present the UE’s 302 utilization of the one or more premium features to downstream platforms, while the control center 320 may lack an ability to segment the UE’s 302 utilization of the one or more premium features from the UE’s 302 utilization of basic features. Thus, by communicating the online CDR to the API manager 340, downstream presentation of the UE’s 302 utilization of basic features may be segmented from the presentation of the UE’s 302 utilization of the one or more premium features.

At a twenty-first step 384, the API manager 340 communicates the UE’s 302 utilization of the one or more premium features (which may have been extracted from and/or collected from the online CDR at the eighteenth step 378) to the enterprise platform 342. In aspects, the API manager 340 communicates the online metered CDR to the enterprise platform 342, from which the UE’s 302 utilization of the one or more premium features may be extracted and/or collected for presentation at the enterprise platform 342. In aspects, the enterprise platform 342 presents the UE’s 302 utilization of the one or more premium features such that the one or more users and/or enterprises may view the UE’s 302 utilization of the one or more premium features.

At a twenty-second step 386, the control center 320 communicates the UE’s 302 utilization of basic features (which may be extracted from and/or collected from the offline CDR at the nineteenth step 380) to the enterprise platform 342. In aspects, the control center 320 communicates the offline CDR to the enterprise platform 342, from which the UE’s 302 utilization of basic features may be extracted and/or collected for presentation at the enterprise platform 342. In aspects, the enterprise platform 342 presents the UE’s 302 utilization of the basic features such that the one or more users and/or enterprises may view the UE’s 302 utilization of basic features.

Advantageously, by segmenting the UE’s 302 utilization of premium (e.g., typically more expensive) features and basic (e.g., typically less expensive) features to allow the separate presentation of each, the one or more users and/or enterprises may more accurately determine the source of additional costs within their enterprises. For example, if a bill for the UE 302 is $150 a month for the UE’s 302 collective utilization of the one or more premium features and the basic features, the enterprise may be unable to determine which premium feature and/or basic feature is predominantly responsible for the collective total. By segmenting the UE’s 302 utilization of the one or more premium features from the UE’s 302 utilization of the basic features, the enterprise may more accurately reflect on the costs of the UE 302.

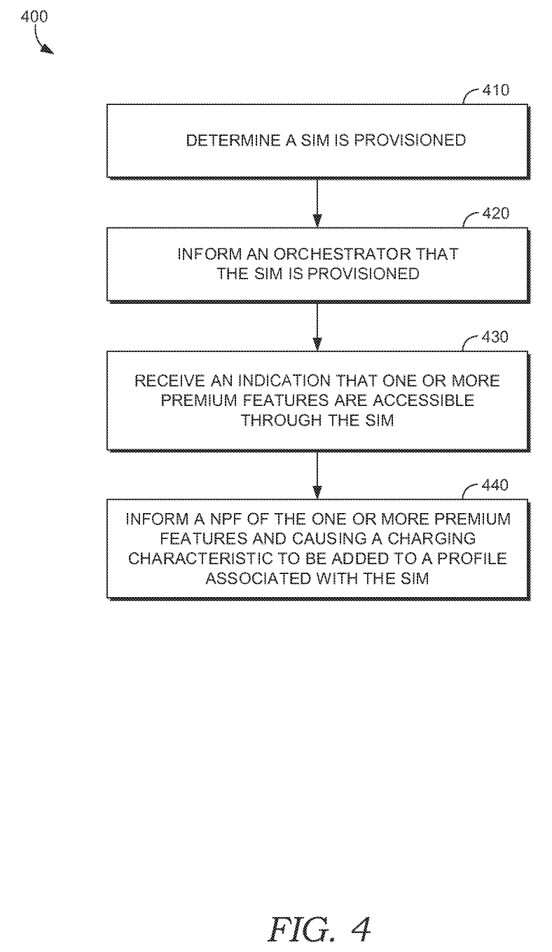

Now referring to FIG. 4, a flow chart is provided that illustrates one or more aspects of the present disclosure relating to a method 400 for generating virtual DNNs within a network. The method 400 may include any one or more aspects described with respect to FIGS. 2-3.

At a first step 410, the method 400 includes determining, by a SPA (e.g., the SPA 222 of FIG. 2, the SPA 322 of FIG. 3) a SIM is activated, as described with respect to FIG. 3. In aspects, the SIM is associated with a UE (e.g., the first UE 202 and/or the second UE 204 of FIG. 2, the UE 302 of FIG. 3). At a second step 420, the SPA informs an orchestrator (e.g., the orchestrator 224 of FIG. 2, the orchestrator 324 of FIG. 3) that the SIM is activated, as described with respect to FIG. 3. In aspects, the SPA informs the orchestrator in response to a request from the orchestrator and/or once the orchestrator accesses the SPA. At a third step 430, the method 400 includes receiving, by the SPA, an indication that one or more premium features are accessible through the SIM, as described with respect to FIG. 3. In aspects, the SPA receives the indication from the orchestrator, which may initially cause the activation of the one or more premium features. At a fourth step 440, the method 400 includes informing, by the SPA, an NPF (e.g., the NPF 226 of FIG. 2, the NPF 326 of FIG. 3) of the one or more premium features. In aspects, the SPA communicates an indication that the one or more premium features have been activated and/or provisioned, as described with respect to FIG. 3. At the fourth step 440, the SPA informing the NPF may cause one or more charging characteristics to be added to a profile associated with the SIM, as described with respect to FIG. 3.

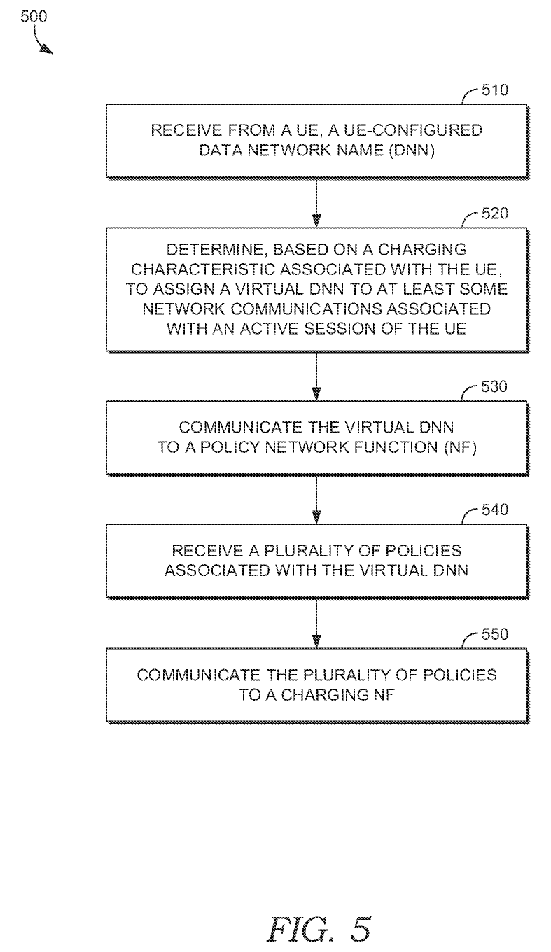

Now referring to FIG. 5, a flow chart is provided that illustrates one or more aspects of the present disclosure relating to a method 500 for generating virtual DNNs within a network. The method 500 may include any one or more aspects described with respect to FIGS. 2-4.

At a first step 510, the method 500 includes receiving, at a session NF (e.g., the session NF 232 of FIG. 2, the session NF 332 of FIG. 3) and from a UE (e.g., the first UE 202 and/or the second UE 204 of FIG. 2, the UE 302 of FIG. 3) a UE-configured DNN, as described with respect to FIG. 3. At a second step 520, the method 500 includes determining, at the session NF and based on a charging characteristic associated with the UE, to assign a virtual DNN to at least some network communications associated with the active session of the UE. In aspects, the determination to assign the virtual DNN is based on one or more rules associated with the one or more premium features, such as the hotspot determinations and/or the QoD determinations described with respect to FIG. 3.

At a third step 530, the method 500 includes communicating, by the session NF, the virtual DNN to a policy NF (e.g., the policy NF 234 of FIG. 2, the policy NF 334 of FIG. 3), as described with respect to FIG. 3. In aspects, the policy NF may locate and/or identify a CRBN associated with the virtual DNN, and the CRBN may be associated with one or more policies associated with the virtual DNN and/or the premium feature. At a fourth step 540, the method 500 includes receiving, by the session NF, a plurality of policies associated with the virtual DNN, as described with respect to FIG. 3. In aspects, the plurality of policies are associated with the CRBN retrieved by the policy NF in the third step 530. At a fifth step 550, the method 500 includes communicating, by the session NF, the plurality of policies to a charging NF (e.g., the charging NF 236 of FIG. 2, the charging NF 336 of FIG. 3), as described with respect to FIG. 3. In aspects, the charging NF may enforce and/or cause the enforcement of the one or more policies during the online and offline charging of the UE’s utilization of one or more features within the network.

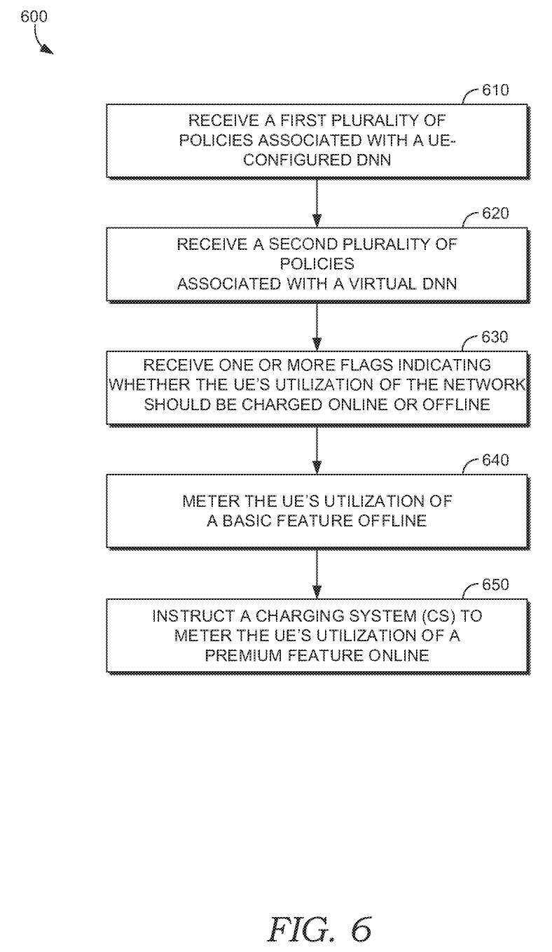

Now referring to FIG. 6, a flow chart is provided that illustrates one or more aspects of the present disclosure relating to a method 600 for utilizing virtual DNNs within a network. The method 500 may include any one or more aspects described with respect to FIGS. 2-5.

At a first step 610, the method 600 includes receiving, at a charging NF (e.g., the charging NF 236 of FIG. 2, the charging NF 336 of FIG. 3), a plurality of policies of a first CRBN associated with a UE-configured DNN, as described with respect to FIG. 3. At a second step 620, the method 600 includes receiving, at the charging NF, a plurality of policies of a second CRBN associated with a virtual DNN, as described with respect to FIG. 3. At a third step 630, the method 600 includes receiving, by the charging NF, one or more flags indicating whether the UE’s utilization of the network should be charged online or offline, as described with respect to FIG. 3. In some aspects, the one or more flags may comprise the UE-configured DNN or the virtual DNN. At a fourth step 640, the method 600 includes metering, by the charging NF, the UE’s utilization of a basic feature offline, as described with respect to FIG. 3. At a fifth step 650, the method 600 includes instructing, by the charging NF, a CS (e.g., the CS 230 of FIG. 2, the CS 330 of FIG. 3) to meter the UE’s utilization of a premium feature online, as described with respect to FIG. 3. In aspects, the premium feature may be hotspot or QoD.

What is claimed is:

1. A method for generating virtual data network names (DNNs) in a network, the method comprising:
determining, by a subscriber provisioning application, a subscriber identity module (SIM) is provisioned;
informing an orchestrator that the SIM is provisioned;
receiving an indication that one or more premium features are accessible through the SIM; and
informing a network provisioning function (NPF) of the one or more premium features, wherein the communicating causes a charging characteristic to be added to a profile associated with the SIM, and wherein the communicating causes the one or more premium features to be communicated to a charging system (CS).

2. The method of claim 1, wherein the profile associated with the SIM is stored at a unified data management (UDM) function.

3. The method of claim 1, wherein, when a user equipment (UE) associated with the SIM initiates communication with the network, a session network function (NF) accesses the charging characteristic to determine whether the session NF will generate a virtual data network name (DNN).

4. A method for generating virtual data network names (DNNs) within a network, the method comprising:
receiving, at a session network function (NF), from a user equipment (UE), a UE-configured data network name (DNN);
determining, based on a charging characteristic associated with the UE, to assign a virtual DNN to at least some network communications associated with an active session of the UE;
communicating the virtual DNN to a policy NF;
receiving a plurality of policies associated with the virtual DNN; and
communicating the plurality of policies to a charging NF.

5. The method of claim 4, wherein the virtual DNN reflects a premium feature associated with the UE.

6. The method of claim 5, wherein the premium feature is one or more of hotspot and quality on demand (QoD).

7. The method of claim 6, wherein the determining is further based on at least one hotspot determination.

8. The method of claim 7, wherein the at least one hotspot determination comprises determining a time to live (TTL) of a communication from the UE during the active session is different than a default TTL associated with the UE.

9. The method of claim 6, wherein the determining is further based on at least one QoD determination.

10. The method of claim 9, wherein the at least one QoD determination comprises determining the UE is utilizing a network slice different than a default network slice of the UE.

11. The method of claim 10, wherein the plurality of policies associated with the virtual DNN indicate whether the UE’s usage of the network should be charged online or offline.

12. A method for charging a UE within a network, the method comprising:
receiving, at a charging NF, a first plurality of policies associated with a UE-configured data network name (DNN), wherein the UE-configured DNN indicates the UE is utilizing a basic feature;
receiving, a second plurality of policies associated with a virtual DNN, wherein the virtual DNN indicates the UE is utilizing a premium feature;
receiving one or more flags from a session network function (NF), wherein the one or more flags indicate whether the UE’s utilization of the network should be charged online or offline;
metering the UE’s utilization of the basic feature offline; and
instructing a charging system (CS) to meter the UE’s utilization of the premium feature online.

13. The method of claim 12, wherein the premium feature is one of hotspot and quality on demand (QoD).

14. The method of claim 13, further comprising generating an offline call detail record (CDR) associated with the UE-configured DNN and causing the generation of an online CDR associated with the virtual DNN.

15. The method of claim 14, wherein each of the offline CDR and the online CDR are communicated to a mediator, wherein the mediator determines where to communicate the offline CDR and the online CDR to based on the virtual DNN and the UE-configured DNN.

16. The method of claim 15, wherein the mediator communicates the online CDR to an application programming interface (API) manager based on a presence of the virtual DNN, and wherein the mediator communicates the offline CDR to a control center based on a presence of the UE-configured DNN.

17. The method of claim 16, wherein the API manager communicates the online CDR to the control center, and wherein the control center rates each of the offline CDR and the online CDR.

18. The method of claim 16, wherein the API manager generates online usage based on the online CDR and the control center generates offline usage based on the offline CDR, wherein the online usage and the offline usage are communicated to an enterprise platform, and wherein each of the online usage and the offline usage are presented separately at the enterprise platform.

19. The method of claim 17, wherein the UE is an internet of things (IoT) device, and wherein the UE is associated with an enterprise.

20. The method of claim 17, wherein the one or more flags is one or more of: a network slice identifier and a time to live (TTL) associated with a communication from the UE during an active session.
